(19) United States
(12) Patent Application Publication
(10) Pub. No.: US 2014/0379451 A1
(43) Pub. Date: Dec. 25, 2014

(54) TARGETED-ADVERTISEMENT-BASED EVENT SAVINGS PROGRAM

(71) Applicant: THE BANK OF NEW YORK MELLON, New York, NY (US)

(72) Inventors: Jennifer C. Cole, Bryn Mawr, PA (US); Aniko N. Delaney, New York, NY (US); Douglas J. Magnolia, New York, NY (US); Scott F. Posner, New York, NY (US); Mark I. Robinson, New York, NY (US)

(73) Assignee: The Bank of New York Mellon

(21) Appl. No.: 13/926,720

(22) Filed: Jun. 25, 2013

(51) Int. Cl. G06Q 30/02

(52) U.S. Cl. CPC G06Q 30/0224
USPC 705/14.25

(57) ABSTRACT

Approaches to facilitating targeted-advertisement-based event savings programs are provided. In certain implementations, a product or service type may be associated with a user. An advertisement identifying a product or service that relates to the associated product or service type may be provided for presentation to the user. A purchase of the product or service by the user responsive to providing the advertisement may be determined. An amount may be credited to an account on behalf of a beneficiary associated with user based on the purchase of the product or service by the user. In some implementations, a credit amount associated with purchasing the product or service may be determined. An estimated future value of the credit amount with respect to a time that corresponds to a predetermined life event associated with the account may be determined. The estimated future value may be provided for presentation to the user.

### FIELD OF THE DISCLOSURE

This disclosure relates generally to a targeted-advertisement-based event savings program.

### BACKGROUND

Discounts, rewards, and other promotional programs are frequently implemented by retailers, manufacturers, etc., to encourage loyal purchasing behavior. Typical promotional programs may, for example, encourage loyal purchasing behavior by offering immediate cost savings and other incentives in exchange. However, while typical promotional programs may allow consumers to reap short-term gratification by participating in such programs, consumers often fail to accumulate the cost savings and other incentives to fund important future life events. These and other drawbacks exist.

### SUMMARY

One aspect of the disclosure relates to a system configured to facilitate a targeted-advertisement-based event savings program, in accordance with one or more implementations. In exemplary implementations, users may be targeted to purchase certain products or services associated with one or more particular product or service brands based on product or services types that the users may be interested in purchasing. In exchange for purchasing the product or services associated with the product or service brands, one or more accounts associated with beneficiaries of the users may be credited with certain amounts based on the purchased products or services, the brands associated with the purchased products or services, or other criteria. The credited amounts may be allocated to one or more predetermined life events associated with the accounts to facilitate saving for the predetermined life events on behalf of the beneficiaries. In this way, among other benefits, the system may encourage brand loyalty and help address funding needs for specific life events.

In some implementations, the system may include one or more servers. The server(s) may be configured to communicate with one or more client computing platforms according to a client/server architecture. The users may access the system via the client computing platforms.

The server(s) may be configured to execute one or more computer program modules to facilitate a targeted-advertisement-based event savings program. The computer program modules may include one or more of an association module, an advertising module, a transaction module, a benefit module, a financial education module, and/or other modules. In some implementations, the client computing platforms may be configured to execute one or more computer program modules that are the same as or similar to the computer program modules of the server(s) to facilitate a targeted-advertisement-based event savings program.

The association module may be configured to associate one or more product or service types with a user. In certain implementations, the association module may be configured to determine demographic information associated with the user, and associate the product or service types with the user based on the demographic information. In various implementations, the association module may be configured to determine one or more selections of the product or service types by the user, and associate the product or service types with the user based on the selections of the product or service types.

The advertising module may be configured to provide one or more advertisements that identify one or more products or services relating to the associated product or service types for presentation to the user. In some implementations, the advertising module may be configured to provide the advertisements that identify the products or services based on a determination that the products or services relate to the associated product or service types and one or more pre-selected product or service brands.

The transaction module may be configured to determine a purchase of at least one of the products or services (relating to the associated product or service types) by the user responsive to providing the advertisements. The benefit module may be configured to credit an amount to an account on behalf of a beneficiary associated with the user based on the purchase of the at least one product or service by the user.

In certain implementations, the benefit module may be configured to provide an indication of an association of at least one of the pre-selected product or service brands with the crediting of the amount to the account. The indication may, for example, be directed to the user or the beneficiary.

In various implementations, the association module may be configured to determine one or more predetermined life events associated with the account. The association module may be configured to determine a selection of at least one of the predetermined life events by the user to be associated with contributions of the user. The benefit module may be configured to allocate the credited amount for the at least one predetermined life event based on the selection of the at least one predetermined life event.

The financial education module may be configured to determine one or more credit amounts associated with purchasing the products or services. The financial education module may be configured to determine one or more estimated future values of the credit amounts, and provide the estimated future values for presentation to the user. In some implementations, financial education module may be configured to determine the estimated future values of the credit amounts by determining at least one estimated value of at least one of the credit amounts with respect to a time that corresponds to a predetermined life event associated with the account.

In certain implementations, the association module may associate one or more other product or service types with another user (e.g., that is different from the user associated with the beneficiary). The advertising module may be configured to provide one or more other advertisements that identify one or more other products or services relating to the associated other product or service types for presentation to the other user. The transaction module may be configured to determine a purchase of at least one of the other product or services by the other user responsive to providing the other advertisements. The benefit module may be configured to credit another amount to the account based on the purchase of the at least one other product or service by the other user. The beneficiary may be associated with the user and/or the other user.

In various implementations, the benefit module may be configured to credit another amount to another account on behalf of another beneficiary associated with the user based on the purchase of the at least one product or service by the user.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to facilitate a targeted-advertisement-based event savings program, in accordance with one or more implementations.

FIG. 2 illustrates an advertisement that presents a product for sale, a credit amount associated with purchase of the product, and an estimated future value of the credit amount, in accordance with one or more implementations.

FIG. 3 illustrates a user interface for facilitating a targeted-advertisement-based event savings program, in accordance with one or more implementations.

FIGS. 4 and 5 illustrate methods for facilitating a targeted-advertisement-based event savings program, in accordance with one or more implementations.

### DETAILED DESCRIPTION

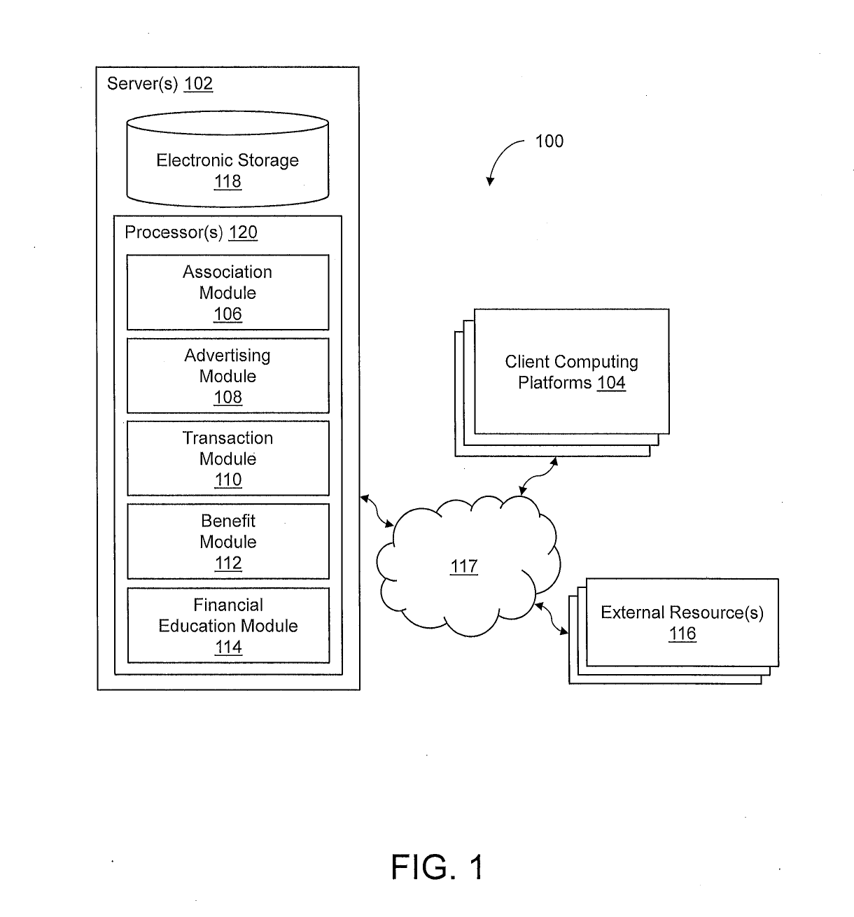

FIG. 1 illustrates a system 100 configured to facilitate a targeted-advertisement-based event savings program, in accordance with one or more implementations. In exemplary implementations, users may be targeted to purchase certain products or services associated with one or more particular product or service brands based on product or services types that the users may be interested in purchasing. The product or service types of interest may be determined based on demographic information associated with the users, selection of the product or services types by the users, or other criteria. In exchange for purchasing the product or services associated with the product or service brands, one or more accounts associated with beneficiaries of the users may be credited with certain amounts based on the purchased products or services, the brands associated with the purchased products or services, or other criteria. The credited amounts may be allocated to one or more predetermined life events associated with the accounts to facilitate saving for the predetermined life events on behalf of the beneficiaries. In addition, indications of associations of the brands with the credited amounts may be provided for presentation to the users to allow the users to see how much the various brands are contributing to fund the predetermined life events. In this way, among other benefits, the system may encourage brand loyalty and help address funding needs for specific life events.

In some implementations, system 100 may include one or more servers 102. Server(s) 102 may be configured to communicate with one or more client computing platforms 104 according to a client/server architecture. The users may access system 100 via client computing platforms 104.

Server(s) 102 may be configured to execute one or more computer program modules to facilitate a targeted-advertisement-based event savings program. The computer program modules may include one or more of an association module 106, an advertising module 108, a transaction module 110, a benefit module 112, a financial education module 114, and/or other modules. In some implementations, client computing platforms 104 may be configured to execute one or more computer program modules that are the same as or similar to the computer program modules of server(s) 102 to facilitate a targeted-advertisement-based event savings program.

Association module 106 may be configured to associate one or more product or service types with a user. In certain implementations, association module 106 may be configured to determine demographic information associated with the user, and associate the product or service types with the user based on the demographic information. In one use case, an event-based savings program may target users that are part of the new or young family demographic. As such, those users may be associated with product or service types that relate to the needs and desires of new or young families. These product types may, for example, include diapers, strollers, baby or toddler toys, baby or toddler clothes, or other product types, and the service types may include day cares, baby development guidance, or other service types.

In various implementations, association module 106 may be configured to determine one or more selections of the product or service types by the user, and associate the product or service types with the user based on the selections of the product or service types. In one scenario, users may select product or services types for which they wish to receive promotional information. Users may, for example, select general product types (e.g., baby products, toddler products, etc.) or specific product types (e.g., diapers, strollers, baby or toddler toys, baby or toddler clothes, etc.). The selected general or specific product types may then be associated with the users.

In one or more implementations, association module 106 may be configured to associate the product or service types with the user based on one or more other criteria. In one use case, purchase history information of the user may be determined. The purchase history information may, for example, include information relating to products or services purchased by the user, price paid by the user for the purchased products or services, retailers from which the user purchased the products or services, dates/times of the purchases of the products or services, feedback from the user with respect to the purchases of the products or services, or other information. One or more product or service types may be then determined based on the purchase history information. The determined product or services types may thereafter be associated with the user.

Advertising module 108 may be configured to provide one or more advertisements that identify one or more products or services relating to the associated product or service types (e.g., the product or service types associated with the user) for presentation to the user. In some implementations, advertising module 108 may be configured to provide the advertisements that identify the products or services based on a determination that the products or services relate to the associated product or service types and one or more pre-selected product or service brands. In one or more implementations, the pre-selected product or services brands may include one or more product brands associated with one or more products, one or more service brands associated with one or more services, etc. In one scenario, for example, the product brands or the service brands may be “official sponsors” of a savings program that are selected to be endorsed by the savings program.

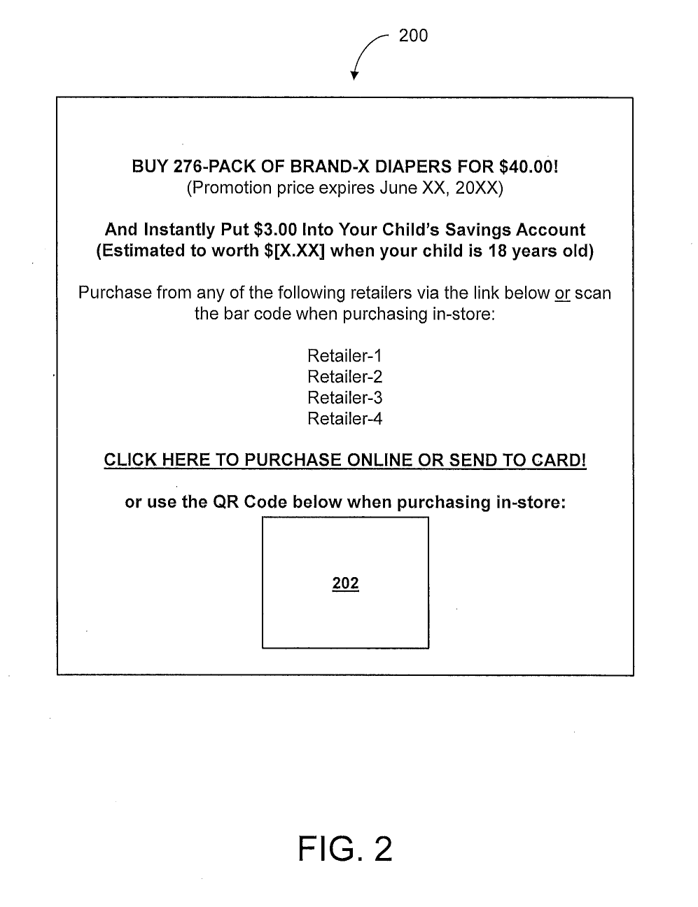

In another scenario, with respect to FIG. 2, Brand-X may be one of a plurality of brands that are pre-selected to be endorsed by advertisements relating to a savings program. Advertisement 200 for Brand-X diapers may be automatically generated or selected for presentation to a user based on an association of diapers with the user and a determination that Brand-X is one of the pre-selected brands to be endorsed.

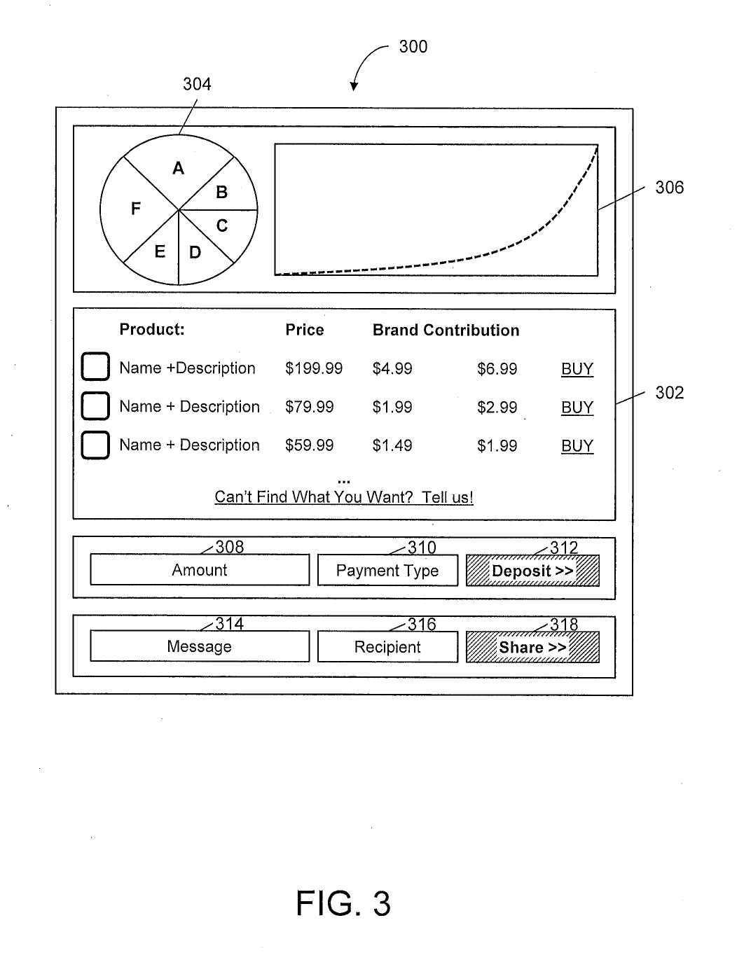

In another scenario, with respect to FIG. 3, user interface 300 may present an information table 302 advertising a plurality of products associated with product brands that have been registered to “contribute” one or more credit amounts associated with individual ones of the products or the product brands in exchange for purchase of the products by users. The listed products of information table 302 may, for example, include products relating to product or service types associated with a user of user interface 300. As discussed, the product or service types may be associated with the user based on demographic information of the user, selections of the product or service types by the user, or other criteria.

Transaction module 110 may be configured to determine a purchase of at least one of the products or services (relating to the associated product or service types) by the user responsive to providing the advertisements. As an example, with respect to FIG. 2, a user may activate the link (e.g., “CLICK HERE TO PURCHASE ONLINE OR SEND TO CARD”) to purchase a pack of Brand-X diapers at any of the listed retailers of Brand-X diapers (e.g., Retailer-1, Retailer-2, Retailer-3, Retailer-4, etc.). In one use case, the user may activate the link to purchase Brand-X diapers from an online store of a listed retailer online. Transaction module 110 may determine that the user has purchased a pack of Brand-X diapers based on the activation of the link (e.g., the link may identify an account of the user, the promotion, or other information, etc.).

In another use case, with respect to FIG. 2, the user may activate the link to send the Brand-X diaper promotion to a card or other token associated with an account of the user. As an example, the user may purchase a pack of Brand-X diapers for the promotion price at a physical store of any of the listed retailers by scanning the card or other token during check-out of the Brand-X diapers. The scanning of the card or token may, for instance, provide an identifier of the promotion associated with the Brand-X diapers, an identifier associated with the account of the user, or other information during check-out. As such, based on the scanning of the card or other token, the store check-out system or the card/token may indicate to transaction module 110 that the user has purchased a pack of Brand-X diapers.

In another use case, with respect to FIG. 2, the user may purchase a pack of Brand-X diapers for the promotion price at a physical store of any of the listed retailers by scanning the Quick Response (QR) Code 202 (or other graphic representation) depicted on advertisement 200 during check-out of the Brand-X diapers. The scanning of QR Code 202 (or other graphical representation) may, for instance, provide an identifier of the promotion associated with the Brand-X diapers, an identifier associated with the account of the user, or other information during check-out. As such, based on the scanning of QR Code 202 (or other graphical representation), the store check-out system may indicate to transaction module 110 that the user has purchased a pack of Brand-X diapers.

In another use case, with respect to FIG. 3, a user of user interface 300 may purchase one of a plurality of products via the individual “BUY” links in information table 302. Each of the links may identify an account of the user, a promotion associated with a product, or other information that allows the purchases of individual ones of the products to be tracked by transaction module 110. In some use cases, one or more of the links may allow the user to select one of a plurality of retailers from which to purchase the promoted products associated with the links.

Benefit module 112 may be configured to credit an amount to an account on behalf of a beneficiary associated with the user based on the purchase of the at least one product or service by the user. In one scenario, with respect to FIG. 2, a savings account created on behalf of a beneficiary associated with a user may be credited with $3.00 when the user purchases a pack of Brand-X diapers at one of the listed retailers. As an example, the beneficiary may be a child, and the user may be a parent, a grandparent, or other family member related to the child. The user may create the savings account on behalf of the child such that the user or other users may contribute to the savings account by purchasing products or services associated with targeted product or service brands.

In another scenario, with respect to FIG. 3, different credit amounts may be associated with purchases of the same product from different retailers. As an example, a savings program may have preferred retailers and regular retailers that are registered with the savings program. A parent may create a savings account relating to the savings program on behalf of her child. User interface 300 may, for instance, represent an interface utilized by the parent to check on the savings account of the child and to purchase products (or services) targeted for the parent. If the parent utilizes the “BUY” link of the first listed product in information table 302 to purchase the associated product from a regular retailer (e.g., activation of the link may offer the parent a choice of retailers from which to purchase the product), the savings account of the child may be credited with $4.99. On the other hand, if the parent utilizes the “BUY” link of the first listed product to purchase the associated product from a preferred retailer, the savings account of the child may be credited with $6.99.

In certain implementations, benefit module 112 may be configured to provide an indication of an association of at least one of the pre-selected product or service brands with the crediting of the amount to the account. The indication may, for example, be directed to the user or the beneficiary. In one scenario, with respect to FIG. 2, when the user purchases a pack of Brand-X diapers online via the purchase link on advertisement 200, the user may be presented with a notification that Brand-X provided $3.00 to the savings account for the child beneficiary. In this way, among other benefits, loyalty by the user to Brand-X may be developed.

In another scenario, with respect to FIG. 3, a parent may create a savings account on behalf of her child. User interface 300 may, for instance, represent an interface utilized by the parent to check on the savings account of the child and to purchase products or services targeted for the parent. Graph 304 may represent the percentages of the contributions by each of the various brands (e.g., Brand-A, Brand-B, Brand-C, Brand-D, Brand-E, Brand-F, etc.) to an overall savings amount of the savings account of the child. Specifically, although each of the amounts credited to the savings account responsive to purchases of products or services associated with one or more of the depicted brands may generally be small, the overall credited amount by each of the brands may be significant with respect to funding a predetermined life event. Graph 304 may, for example, show the parent how much each of the brands have contributed to funding the predetermined life event. Graph 306 may show the parent the overall savings amount (e.g., calculated from individual credit amounts, interest amounts, etc.) to which all of the brands have contributed at various times (e.g., past overall amounts, a current overall amount, future estimated values of the current overall amount, etc.). In this way, among other benefits, users may develop loyalty to the brands that have seen contributed significantly to important predetermined life events of their beneficiaries (e.g., themselves, spouses, children, grandchildren, parents, etc.).

In various implementations, association module 106 may be configured to determine one or more predetermined life events associated with the account. Association module 106 may be configured to determine a selection of at least one of the predetermined life events by the user to be associated with contributions of the user. Benefit module 112 may be configured to allocate the credited amount for the at least one predetermined life event based on the selection of the at least one predetermined life event.

By way of example, predetermined life events may be include birth, age of majority (e.g., 18 years old), parenthood, grandparenthood, college, first car purchase, first house purchase, or other predetermined life events. Predetermined life events associated with an account may include a default set of predetermined life events, a set of predetermined life events created or selected by a user, or other predetermined life events. In one use case, a parent may create an investment account on behalf of her child. The investment account may enable the parent to choose one or more of a plurality of available predetermined life events (e.g., age of majority, parenthood, grandparenthood, college, first car purchase, first house purchase, etc.) to which amounts credited through the parent's purchases of targeted products or services are to be allocated. If, for instance, the parent selects the child's age of majority as a predetermined life event for which money is to be saved, the amounts credited through the parent's purchases may be allocated to one or more investments based on the child's age of majority. On the other hand, if the parent selects the child's first car purchase as a predetermined life event for which money is to be saved, the amounts credited through the parent's purchases may be allocated to one or more investments based on a date/time for the first car purchase (e.g., a predicted date/time by the system, the parent, etc.)

Financial education module 114 may be configured to determine one or more credit amounts associated with purchasing the products or services. Financial education module 114 may be configured to determine one or more estimated future values of the credit amounts, and provide the estimated future values for presentation to the user. In some implementations, financial education module may be configured to determine the estimated future values of the credit amounts by determining at least one estimated value of at least one of the credit amounts with respect to a time that corresponds to a predetermined life event associated with the account. For example, with respect to FIG. 2, financial education module 114 may determine that a credit amount associated with purchasing a pack of Brand-X diapers is $3,00, and then generate an estimated future value (e.g., $[X.XX]) of the credit amount on the date corresponding to the age of majority of user's child for presentation to the parent of the user. In this way, among other benefits, financial education module 114 may provide users with financial education and present users with opportunities for greater reward realizations from the product or service purchases.

In certain implementations, association module 106 may associate one or more other product or service types with another user (e.g., that is different from the user associated with the beneficiary). Advertising module 108 may be configured to provide one or more other advertisements that identify one or more other products or services relating to the associated other product or service types for presentation to the other user. Transaction module 110 may be configured to determine a purchase of at least one of the other product or services by the other user responsive to providing the other advertisements. Benefit module 112 may be configured to credit another amount to the account based on the purchase of the at least one other product or service by the other user. The beneficiary may be associated with the user and/or the other user.

By way of example, with respect to FIG. 3, a parent may create a savings account on behalf of her child. The savings account may, for instance, be independent of the parent's user account with a savings program or integrated with the parent's user account. In response to purchases of products or services targeted for the parent, the savings account may be credited with respective amounts associated with the purchases of the products or services. To further fund the savings amount, the parent may also deposit money into the savings account by specifying the deposit amount in amount box 308, specifying the payment type in payment type box 310, and activating the deposit box 312. In addition, the parent may share the ability to fund the savings account of the child with other users (e.g., grandparents, aunts, uncles, cousins, friends, etc.) by specifying a message in message box 314, specifying one or more other users in the recipient box 316, and activating the share box 318.

In one use case, a parent and a grandparent may both help fund a savings account of a child by purchasing products or services targeted for the parent or the grandparent. The parent may be associated with a first set of product or service types, and the grandparent may be associated with a second set of products or service types that are different from the first set of products or service types. As such, the parent and the grandparent may be presented with different advertisements identifying different products or services. Nonetheless, purchases of the advertised products by the parent and the grandparent, respectively, may result in crediting of the savings account of the child with credit amounts associated with the purchases. As indicated, although individual credit amounts may generally be small, the overall amount that is credited to the savings account may be significant with respect to funding a predetermined life event of the child. In addition, the ability to have multiple users make purchases to fund the savings account may substantially increase the pool of capital that may be invested for the child's future.

In various implementations, benefit module 112 may be configured to credit another amount to another account on behalf of another beneficiary associated with the user based on the purchase of the at least one product or service by the user. For example, the beneficiary and the other beneficiary may both be associated with the user. In one scenario, a parent may have multiple children, and may wish to help fund the savings accounts of all of her children. As such, the parent may specify the percentages of the credit amounts that each of the savings accounts is to be provided responsive to the purchases of products or services targeted for the parent. In another scenario, the parent may specify product or services types to be associated with individual ones of her children such that a savings account of a first child may be credited responsive to a purchase of a product or service associated with a first type and a savings account of a second child may be credited responsive to a purchase of a product or service associated with a second type.

In certain implementations, accounts for beneficiaries and/or their life events may be funded by one or more sources in addition to or in lieu of capital sources described above. For example, sources of funds may include one or more of financial credit providers, online retailers partners, consumer packaged goods partners, personal value added tax (P-VAT), charitable foundations, a savings program managing the accounts for the beneficiaries and/or their life events, voluntary cash contributions, or other sources.

In one use case, with respect to financial credit providers (e.g., Visa, Amex, MasterCard, etc.), consumers may accumulate funds on behalf of beneficiary/life event accounts by making purchases with a registered card. For example, a consumer may be rewarded with cash awards by registering a financial credit provider card with a savings program managing the beneficiary/life event accounts and using the registered card to make purchases. An Amex charge using a registered Amex card may, for instance, result in 1 membership reward point, which may be converted to half a membership reward point for an Amex reward program along with a cash award for a beneficiary/life event account managed by a savings program with which the Amex card is registered.

In another use case, with respect to online retail partners (e.g., Amazon.com, Diapers.com, iTunes.com, etc.), consumers may accumulate funds by making purchases through the online retail partner. For example, consumer loyalty to an online retailer may be rewarded based on a percentage or other basis for purchases made through the online retailer. In another use case, with respect to consumer packaged goods partners (e.g., Proctor & Gamble, Johnson & Johnson, etc.), consumers may accumulate funds on purchases of partner products. For example, consumer loyalty to partner brands may be rewarded.

In another use case, with respect to P-VAT, a consumer may opt to have her credit card provider add a specific dollar amount to each purchase made using a credit card of the credit card provider that is registered with a savings program managing a beneficiary/life event account associated with the consumer. When the credit card is paid each month by the consumer, the credit card provider may deposit the current month's total P-VAT amounts to the beneficiary/life event account.

In another use case, charitable foundations (e.g., Bill & Melinda Gates Foundation, Rockefeller Foundation, etc.) may support a savings program managing beneficiary/life event accounts through the act of charitable donations. Their charitable donations may, for instance, be uniformly divided among beneficiaries of the savings program who may be eligible for pro rata charitable donation funding. In another use case, the savings program may utilize a percentage of its revenue to fund eligible beneficiary/life event accounts. In another use case, a participant/user of the savings program may arrange to have a portion of her income deposited into a particular beneficiary/life event account on a one-time basis, a reoccurring basis, or other basis.

Server(s) 102, client computing platforms 104, external resources 116, and/or other components may be operatively linked via one or more electronic communication links. For example, such electronic communication links may be established, at least in part, via a network 117 such as the Internet and/or other networks. It will be appreciated that this is not intended to be limiting, and that the scope of this disclosure includes implementations in which server(s) 102, client computing platforms 104, external resources 116, and/or other components may be operatively linked via some other communication media.

A given client computing platform 104 may include one or more processors configured to execute computer program modules. The computer program modules may be configured to enable an expert or user associated with client computing platform 104 to interface with system 100 and/or external resources 116, and/or provide other functionality attributed herein to client computing platforms 104. By way of non-limiting example, client computing platform 104 may include one or more of a desktop computer, a laptop computer, a handheld computer, a netbook, a smartphone, a gaming console, and/or other computing platforms.

External resources 116 may include sources of information, hosts and/or providers of virtual spaces outside of system 100, external entities participating with system 100, and/or other resources. In some implementations, some or all of the functionality attributed herein to external resources 116 may be provided by resources included in system 100.

In some implementations, server(s) 102 may include an electronic storage 118, one or more processor(s) 120, and/or other components. Server(s) 102 may include communication lines, or ports to enable the exchange of information with network 117 and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 118 may comprise non-transitory storage media that electronically stores information. The electronic storage media of electronic storage 118 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 118 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 118 may include one or more virtual storage resources (e.g., cloud storage, a virtual private network, and/or other virtual storage resources). Electronic storage 118 may store software algorithms, information determined by processor(s) 120, information received from server(s) 102, information received from client computing platforms 104, and/or other information that enables server(s) 102 to function as described herein.

Processor(s) 120 is configured to provide information processing capabilities in server(s) 102. As such, processor(s) 120 may include one or more of a digital processor, an analog processor, a digital circuit designed to process information, an analog circuit designed to process information, a state machine, and/or other mechanisms for electronically processing information. Although processor(s) 120 is shown in FIG. 1 as a single entity, this is for illustrative purposes only. In some implementations, processor(s) 120 may include a plurality of processing units. These processing units may be physically located within the same device, or processor(s) 120 may represent processing functionality of a plurality of devices operating in coordination. Processor(s) 120 may be configured to execute modules 106, 108, 110, 112, 114, and/or other modules. Processor(s) 120 may be configured to execute modules 106, 108, 110, 112, 114, and/or other modules by software; hardware; firmware; some combination of software, hardware, and/or firmware; and/or other mechanisms for configuring processing capabilities on processor(s) 120. As noted, in certain implementations, a given client computing platform 104 may include one or more computer program modules that is the same as or similar to the computer program modules of server(s) 102. Client computing platform 104 may include one or more processors that are the same or similar to processor(s) 120 of server(s) 102 to execute such computer program modules of client computing platform 104.

It should be appreciated that although modules 106, 108, 110, 112, and 114 are illustrated in FIG. 1 as being co-located within a single processing unit, in implementations in which processor(s) 120 includes multiple processing units, one or more of modules 106, 108, 110, 112, and/or 114 may be located remotely from the other modules. The description of the functionality provided by the different modules 106, 108, 110, 112, and/or 114 described below is for illustrative purposes, and is not intended to be limiting, as any of modules 106, 108, 110, 112, and/or 114 may provide more or less functionality than is described. For example, one or more of modules 106, 108, 110, 112, and/or 114 may be eliminated, and some or all of its functionality may be provided by other ones of modules 106, 108, 110, 112, and/or 114. As another example, processor(s) 120 may be configured to execute one or more additional modules that may perform some or all of the functionality attributed below to one of modules 106, 108, 110, 112, and/or 114.

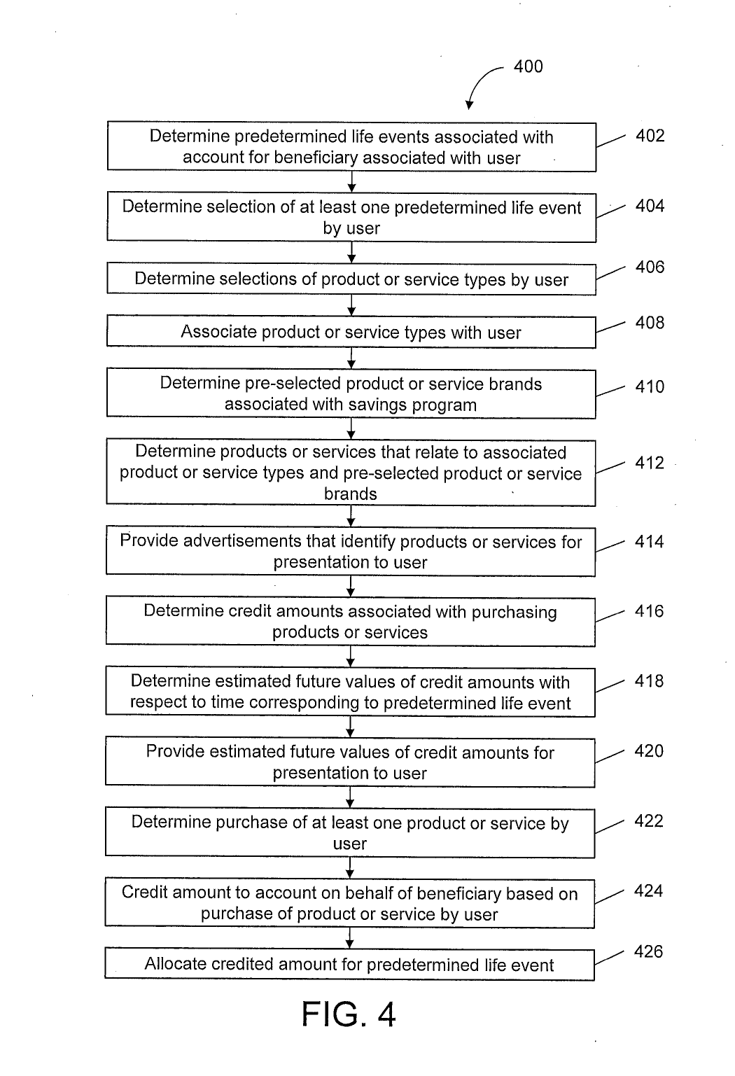

FIG. 4 illustrates a method for facilitating a targeted-advertisement-based event savings program, in accordance with one or more implementations. The operations of method 400 presented below are intended to be illustrative. In some implementations, method 400 may be accomplished with one or more additional operations not described, and/or without one or more of the operations discussed. Additionally, the order in which the operations of method 400 are illustrated in FIG. 4 and described below is not intended to be limiting.

In some implementations, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

At an operation 402, one or more predetermined life events associated with an account on behalf of a beneficiary associated with a user may be determined. Operation 402 may be performed by an association module that is the same as or similar to association module 106, in accordance with one or more implementations.

At an operation 404, a selection of at least one of the predetermined life events by the user may be determined. Operation 404 may be performed by an association module that is the same as or similar to association module 106, in accordance with one or more implementations.

At an operation 406, one or more selections of one or more product or service types by the user may be determined. Operation 406 may be performed by an association module that is the same as or similar to association module 106, in accordance with one or more implementations.

At an operation 408, the product or service types may be associated with the user. Operation 408 may be performed by an association module that is the same as or similar to association module 106, in accordance with one or more implementations.

At an operation 410, one or more pre-selected brands associated with a savings program may be determined. Operation 410 may be performed by an advertising module that is the same as or similar to advertising module 108, in accordance with one or more implementations.

At an operation 412, one or more products or services that relate to the associated product or service types and the pre-selected product or service brands may be determined. Operation 412 may be performed by an advertising module that is the same as or similar to advertising module 108, in accordance with one or more implementations.

At an operation 414, one or more advertisements that identify the products or services may be provided for presentation to the user. Operation 414 may be performed by an advertising module that is the same as or similar to advertising module 108, in accordance with one or more implementations.

At an operation 416, one or more credit amounts associated with purchasing the products or services may be determined. Operation 416 may be performed by a financial education module that is the same as or similar to financial education module 114, in accordance with one or more implementations.

At an operation 418, one or more estimated future values of the credit amounts with respect to a time corresponding to at least one of the predetermined life events (associated with the account of the beneficiary) may be determined. Operation 418 may be performed by a financial education module that is the same as or similar to financial education module 114, in accordance with one or more implementations.

At an operation 420, the estimated future values of the credit amounts may be provided for presentation to the user. In some implementations, the estimated future values of the credit amounts associated with purchasing the product or services may be provided for presentation to the user with the advertisements identifying the products or services. Operation 420 may be performed by a financial education module that is the same as or similar to financial education module 114, in accordance with one or more implementations.

At an operation 422, a purchase of at least one of the products or services by the user may be determined. The purchase of the at least one product or service by the user may, for example, be responsive to at least one of the advertisements identifying the at least one product or service. Operation 422 may be performed by a transaction module that is the same as or similar to transaction module 110, in accordance with one or more implementations.

At an operation 424, an amount may be credited to the account on behalf of the beneficiary based on the purchase of the at least one product or service. For example, in some scenarios, the credited amount may correspond to at least one credit amount associated with the purchase of the at least one product or service. Operation 424 may be performed by a benefit module that is the same as or similar to benefit module 112, in accordance with one or more implementations.

At an operation 426, the credited amount may be allocated for the at least one predetermined life event (associated with the account of the beneficiary). Operation 426 may be performed by a benefit module that is the same as or similar to benefit module 112, in accordance with one or more implementations.

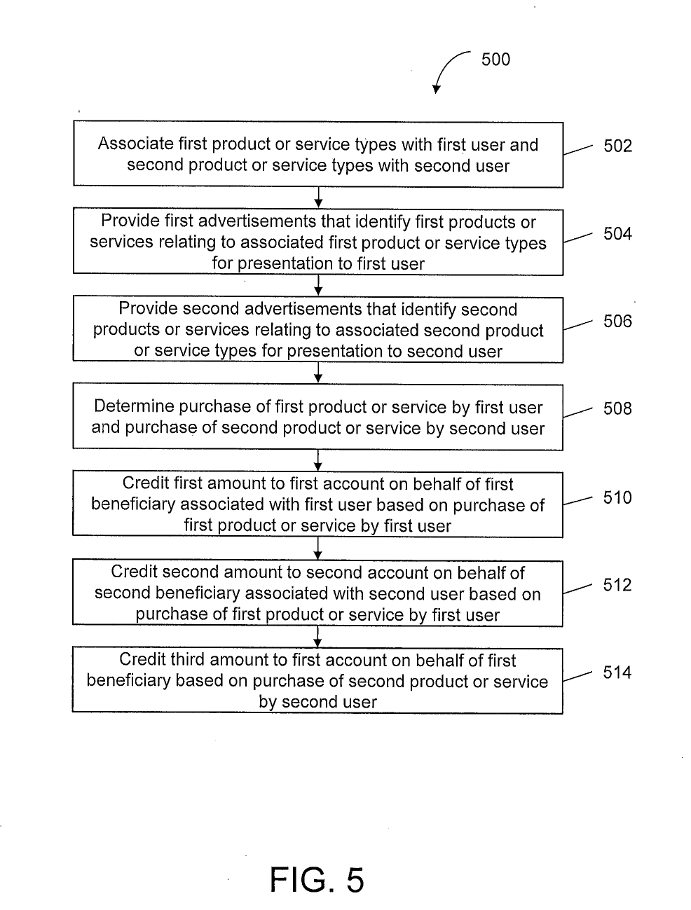

FIG. 5 illustrates a method for facilitating a targeted-advertisement-based event savings program, in accordance with one or more implementations. The operations of method 500 presented below are intended to be illustrative. In some implementations, method 500 may be accomplished with one or more additional operations not described, and/or without one or more of the operations discussed. Additionally, the order in which the operations of method 500 are illustrated in FIG. 5 and described below is not intended to be limiting.

In some implementations, method 500 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 500 in response to instructions stored electronically on an electronic storage medium. The one or more processing devices may include one or more devices configured through hardware, firmware, and/or software to be specifically designed for execution of one or more of the operations of method 500.

At an operation 502, one or more first product or service types may be associated with a first user, and one or more second product or service types may be associated with a second user. Operation 502 may be performed by an association module that is the same as or similar to association module 106, in accordance with one or more implementations.

At an operation 504, one or more first advertisements that identify one or more first product or services relating to the associated first product or service types may be provided for presentation to the first user. Operation 504 may be performed by an advertising module that is the same as or similar to advertising module 108, in accordance with one or more implementations.

At an operation 506, one or more second advertisements that identify one or more second product or services relating to the associated second product or service types may be provided for presentation to the second user. Operation 506 may be performed by an advertising module that is the same as or similar to advertising module 108, in accordance with one or more implementations.

At an operation 508, a purchase of at least one of the first products or services by the first user and a purchase of at least one of the second products or services by the second user may be determined. The purchase of the at least one first product or service by the first user may, for example, be responsive to at least one of the first advertisements identifying the at least one first product or service. The purchase of the at least one second product or service by the second user may be responsive to at least one of the second advertisements identifying the at least one second product or service. Operation 508 may be performed by a transaction module that is the same as or similar to transaction module 110, in accordance with one or more implementations.

At an operation 510, a first amount may be credited to a first account on behalf of a first beneficiary associated with the first user based on the purchase of the at least one first product or service by the first user. Operation 510 may be performed by a benefit module that is the same as or similar to benefit module 112, in accordance with one or more implementations.

At an operation 512, a second amount may be credited to a second account on behalf of a second beneficiary associated with the first user based on the purchase of the at least one first product or service by the first user. Operation 512 may be performed by a benefit module that is the same as or similar to benefit module 112, in accordance with one or more implementations.

At an operation 512, a third amount may be credited to the first account on behalf of the first beneficiary based on the purchase of the at least one second product or service by the second user. The first beneficiary may, for example, be associated with the first user and the second user. Operation 512 may be performed by a benefit module that is the same as or similar to benefit module 112, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A computer-implemented method of facilitating a targeted-advertisement-based event savings program, the method being implemented on a computer system that includes one or more physical processors, the method comprising:
associating, by an association module, one or more product or service types with a user;
providing, by an advertising module, one or more advertisements that identify one or more products or services relating to the associated product or service types for presentation to the user;
determining, by a transaction module, a purchase of at least one of the products or services by the user responsive to providing the advertisements; and
crediting, by a benefit module, an amount to an account on behalf of a beneficiary associated with the user based on the purchase of the at least one product or service by the user.

2. The method of claim 1, wherein providing the advertisements comprise:
providing, by the advertising module, the advertisements that identify the products or services based on a determination that the products or services relate to the associated product or service types and one or more pre-selected product or service brands.

3. The method of claim 2, further comprising:
providing, by the benefit module, an indication of an association of at least one of the pre-selected product or service brands with the crediting of the amount to the account, wherein the indication is directed to the user or the beneficiary.

4. The method of claim 1, further comprising:
determining, by a financial education module, one or more credit amounts associated with purchasing the products or services;
determining, by the financial education module, one or more estimated future values of the credit amounts; and
providing, by the financial education module, the estimated future values for presentation to the user.

5. The method of claim 4, wherein determining the estimated future values of the credit amounts comprise:
determining, by the financial education module, at least one estimated value of at least one of the credit amounts with respect to a time that corresponds to a predetermined life event associated with the account.

6. The method of claim 1, further comprising:
associating, by the association module, one or more other product or service types with another user;
providing, by the advertising module, one or more other advertisements that identify one or more other products or services relating to the associated other product or service types for presentation to the other user;
determining, by the transaction module, a purchase of at least one of the other product or services by the other user responsive to providing the other advertisements; and
crediting, by the benefit module, another amount to the account based on the purchase of the at least one other product or service by the other user, wherein the beneficiary is associated with the other user.

7. The method of claim 1, further comprising:
crediting, by the benefit module, another amount to another account on behalf of another beneficiary associated with the user based on the purchase of the at least one product or service by the user.

8. The method of claim 1, further comprising:
determining, by the association module, demographic information associated with the user, wherein the product or service types are associated with the user based on the demographic information.

9. The method of claim 1, further comprising:
determining, by the association module, one or more selections of the product or service types by the user, wherein the product or service types are associated with the user based on the selections of the product or service types.

10. The method of claim 1, further comprising:
determining, by the association module, one or more predetermined life events associated with the account;
determining, by the association module, a selection of at least one of the predetermined life events by the user to be associated with contributions of the user; and
allocating, by the benefit module, the credited amount for the at least one predetermined life event based on the selection of the at least one predetermined life event.

11. A system for facilitating a targeted-advertisement-based event savings program, the system comprising:
one or more physical processors configured to execute one or more computer program modules, the computer program modules comprising:
an association module configured to one or more product or service types with a user;
an advertising module configured to provide one or more advertisements that identify one or more products or services relating to the associated product or service types for presentation to the user;
a transaction module configured to determine a purchase of at least one of the products or services by the user responsive to providing the advertisements; and
a benefit module configured to credit an amount to an account on behalf of a beneficiary associated with the user based on the purchase of the at least one product or service by the user.

12. The system of claim 11, wherein the advertising module is configured to provide the advertisements that identify the products or services based on a determination that the products or services relate to the associated product or service types and one or more pre-selected product or service brands.

13. The system of claim 12, wherein the benefit module is configured to provide an indication of an association of at least one of the pre-selected product or service brands with the crediting of the amount to the account, wherein the indication is directed to the user or the beneficiary.

14. The system of claim 11, wherein the computer program modules further comprise a financial education module configured to:
determine one or more credit amounts associated with purchasing the products or services;
determine one or more estimated future values of the credit amounts; and
provide the estimated future values for presentation to the user.

15. The system of claim 14, wherein the financial education module is configured to:
determine at least one estimated value of at least one of the credit amounts with respect to a time that corresponds to a predetermined life event associated with the account; and
provide the at least one estimated value of the at least one credit amount for presentation to the user.

16. The system of claim 11, wherein the association module is configured to associate one or more other product or service types with another user, wherein the advertising module is configured to provide one or more other advertisements that identify one or more other products or services relating to the associated other product or service types for presentation to the other user, wherein the transaction module is configured to determine a purchase of at least one of the other product or services by the other user responsive to providing the other advertisements, wherein the benefit module is configured to credit another amount to the account based on the purchase of the at least one other product or service by the other user, and wherein the beneficiary is associated with the other user.

17. The system of claim 11, wherein the benefit module is configured to credit another amount to another account on behalf of another beneficiary associated with the user based on the purchase of the at least one product or service by the user.

18. The system of claim 11, wherein the association module is configured to:
determine demographic information associated with the user; and
associate the product or service types with the user based on the demographic information.

19. The system of claim 11, wherein the association module is configured to:
determine one or more selections of the product or service types by the user; and
associate the product or service types with the user based on the selections of the product or service types.

20. The system of claim 11, wherein the association module is configured to determine one or more predetermined life events associated with the account, and determine a selection of at least one of the predetermined life events by the user to be associated with contributions of the user, and wherein the benefit module is configured to allocate the credited amount for the at least one predetermined life event based on the selection of the at least one predetermined life event.
